(19) United States
(12) Patent Application Publication
(10) Pub. No.: US 2025/0305892 A1
(43) Pub. Date: Oct. 2, 2025

(54) AN APPARATUS FOR DETERMINING SURFACE TEMPERATURE OF AN OBJECT AND A METHOD THEREOF

(71) Applicant: INDIAN INSTITUTE OF TECHNOLOGY MADRAS (ITT MADRAS), Tamil Nadu (IN)

(72) Inventors: Krishnan BALASUBRAMANIAM, Tamil Nadu (IN); Guru Prakash SAHU, Chhattisgarh (IN); Nishanth RAJA, Tamil Nadu (IN)

(73) Assignee: INDIAN INSTITUTE OF TECHNOLOGY MADRAS (ITT MADRAS), Tamil Nadu (IN)

(21) Appl. No.: 18/849,676

(22) PCT Filed: Mar. 14, 2023
(86) PCT No.: PCT/IN2023/050241

§ 371 Date: Sep. 23, 2024

(30) Foreign Application Priority Data
Mar. 24, 2022 (IN) 202241016778

(51) Int. Cl. G01K 11/24; G01N 29/24

(52) U.S. Cl. CPC G01K 11/24; G01N 29/2462

(57) ABSTRACT

The present disclosure relates to an apparatus and a method for determining surface temperature of an object The apparatus includes an elongated waveguide defining a pre-defined cross-section. Further, at least a portion of the waveguide is in contact with a surface of an object whose surface temperature is to be measured. The apparatus further includes a transducer assembly having at least one transducer coupled to the waveguide for supplying ultrasonic signals along at least one segment of the pre-defined cross-section waveguide which is not in contact with the object and for detecting reflected signals from the waveguide. The apparatus also includes a data acquisition unit which is coupled to the transducer to receive the reflected signals and to determine the surface temperature at one or more positions of the object.

### TECHNICAL FIELD

The present disclosure generally relates to the field of sensors and sensing technology for material property. Particularly but not exclusively the present disclosure relates to an apparatus for determining surface temperature of an object.

### BACKGROUND

Surface temperature monitoring is vital for various industrial manufacturing processes such as heat treatment, inductive curing, plasma processing, measurement of casting temperature, and cryogenics. It plays a crucial role to ensure meeting quality standard of final product and workplace safety. Accurate temperature monitoring is essential to achieve a desired microstructure in material of the final products and prevent any defects.

Conventionally, ultrasonic principles is used in non-destructive testing, measurement, and inspection of materials properties of an object or any media in vicinity of the object. This object can be pipelines, boilers, vessels, furnace etc., or any equipment's that are used in industrial manufacturing processes. Ultrasonic principles like pulse echo are used, wherein a transducer introduces high-frequency (ultrasonic) sound wave beams into a wave guide positioned on the object, and reflections (echoes) are captured by a receiver. Any change in temperature of the media (liquid/fluid/gas) in vicinity of the objects, causes change in material property/geometric configuration of the object and it in turn triggers change in velocity of the introduced/reflected sound waves. As a result, the reflected sound waves are distinct if compared to previously calibrated reflections under controlled environment. So, these reflections are received and utilized to interpret and measure a distributed surface temperature over the object, at multi-points along the wave guide. Wave guides have several advantages, including ability to be used over objects that work at high temperatures and hazardous conditions. Wave guides can also be bent and arrange in different configurations to reach tight spaces within the objects.

Wave guides are typically made of metals and are susceptible to cause leakage of ultrasonic sound waves, when attached to the object. This leakage generates undesirable reflections and as a result calibration becomes challenging. Moreover, the wave guides must be replaced or developed frequently as mechanical properties of the wave guide are subject to change due to continuous heat transfer from a contact interface between the object and the wave guide. Thus, leading to leakage and inaccurate results.

The present disclosure is directed to overcome one or more limitations stated above or any other limitations associated with the prior arts.

### SUMMARY OF THE DISCLOSURE

One or more shortcomings of existing apparatus for determining surface temperature have been overcome, and additional advantages are provided through the apparatus as claimed in the present disclosure. Additional features and advantages are realized through the techniques of the present disclosure. Other embodiments and aspects of the disclosure are described in detail herein and are considered a part of the claimed disclosure.

The limitations of the prior arts are addressed to a great extent by an apparatus and a method for determining surface temperature as disclosed in the present disclosure.

In a non-limiting embodiment of the present disclosure by an apparatus and a method for determining surface temperature of an object is disclosed. The apparatus includes an elongated waveguide defining a pre-defined cross-section. Further, at least a portion of the pre-defined cross-section of the elongated waveguide is in contact with a surface of an object whose surface temperature is to be measured. The apparatus further includes a transducer assembly. The transducer assembly includes at least one transducer being coupled to the elongated waveguide for supplying ultrasonic signals into the elongated waveguide and for detecting reflected signals from the elongated waveguide. The transducer is configured to supply the ultrasonic signals along at least one segment of the pre-defined cross-section of the elongated waveguide which is not in contact with the object. The apparatus also includes a data acquisition unit which is coupled to the transducer to receive the reflected signals and to determine the surface temperature at one or more positions of the object.

In an embodiment, the ultrasonic signals are ultrasonic shear horizontal wave signals.

In an embodiment, the elongated waveguide is defined with a series of spaced apart notches or holes to enable multi point measurement of the surface temperature.

In an embodiment, the cross-section of the elongated waveguide is at least of rectangular, circular, cylindrical, elliptical, triangular, I shaped, U shaped, T shaped, V shaped, L shaped, diamond or any polygonal shaped.

In an embodiment, the elongated waveguide is defined with one or more bends.

In an embodiment, the at least one portion of the elongated waveguide that in contact with the object, is made of meta-material.

In an embodiment, the elongated waveguide is defined with grooves adjacent to the at least a portion of the elongated waveguide that in contact with the object and remaining portion of the elongated waveguide.

In an embodiment, the transducer assembly comprises an adjust mechanism to adjust a position of contact of the transducer with the elongated waveguide to shift the segment through which ultrasonic signals are supplied and received.

The present disclosure also discloses a method for determining surface temperature of an object. The method includes initially providing an elongated waveguide defining a predefined cross-section and a portion of the pre-defined cross-section of the elongated waveguide is configured to be in contact with a surface of an object whose surface temperature is to be measured. Later, ultrasonic signals are supplied into the elongated waveguide and reflected signals from the elongated waveguide are detected, using at least one transducer coupled to the waveguide. Further, a position of contact of a transducer coupled with the waveguide (6) is adjusted to shift the segment through which ultrasonic signals are supplied and received. The ultrasonic signals are supplied along at least one segment of the pre-defined cross-section of the elongated waveguide which is not in contact with the object. The surface temperature of the object is determined based on the received reflected signals.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an apparatus for determining for determining surface temperature of an object using flat strip as a waveguide, in accordance with an embodiment of the present disclosure;

FIG. 2 illustrates schematic views of different configurations of the waveguide for determining surface temperature measurement using the apparatus of FIG. 1;

FIG. 3 illustrates schematic views of different configurations of the waveguide employed in objects such as cylindrical conduit and rectangular duct, in accordance with an embodiment of the present disclosure

FIGS. 4a, 4b and 4c illustrates graphical representation of (a) visualization of shear horizontal wave (b) a plot of amplitude (velocity) Vs time (time domain waveforms) recorded at point A and B, (c) a plot of two-dimensional fast Fourier transform (2D FFT) of the generated shear horizontal wave like mode, respectively;

FIGS. 5a, 5b and 5c illustrates (a) the waveguide for sensing, (b) the waveguide inside a furnace for calibration, (c) time domain waveform recorded for the room temperature and 300° C.;

FIGS. 6a, 6b and 6c illustrates a perspective view of a plate assembly with the waveguide, (b) another perspective view of plate assembly having the waveguide, (c) a schematic view of plate assembly having the waveguide for determining surface temperature, in accordance with an embodiment of the present disclosure;

FIGS. 7a and 7b illustrates plots of temperature versus time of flight (ToF) difference for (a) sensor 1 and (b) sensor 2 of FIG. 6a, in accordance with an embodiment of the present disclosure;

FIGS. 8a and 8b illustrates plots of absolute error in temperature prediction obtained for (a) sensor 1 and (b) sensor of FIG. 6a, in accordance with an embodiment of the present disclosure; and

FIG. 9 illustrates time domain waveforms for different configuration of the waveguide, in accordance with an embodiment of the present disclosure.

The figures depict embodiments of the disclosure for purposes of illustration only. One skilled in the art will readily recognize from the following description that alternative embodiments of the apparatus and methods illustrated herein may be employed without departing from the principles of the disclosure described herein.

### DETAILED DESCRIPTION

While the embodiments in the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is to cover all modifications, equivalents, and alternative falling within the scope of the disclosure.

It is to be noted that a person skilled in the art would be motivated from the present disclosure and modify construction of an apparatus to determine surface temperature of an object. However, such modifications should be construed within the scope of the disclosure. Accordingly, the drawings show only those specific details that are pertinent to understand the embodiments of the present disclosure, so as not to obscure the disclosure with details that will be readily apparent to those of ordinary skill in the art having benefit of the description herein.

The terms “comprises,” “comprising,” or any other variations thereof used in the disclosure, are intended to cover a non-exclusive inclusion, such that an apparatus that comprises a list of components does not include only those components but may include other components not expressly listed or inherent to such apparatus, or device. In other words, one or more elements in apparatus proceeded by “comprises . . . a” does not, without more constraints, preclude the existence of other elements or additional elements in the system or device.

The present disclosure relates to an apparatus for determining surface temperature of an object. Conventional apparatus for measuring the surface temperature includes waveguides that are in contact with the surrounding media to detect the temperature. However, waveguides tend to change their properties due to continuous heat transfer between the waveguide and the surrounding media. Therefore, the waveguides are susceptible to cause leakage of ultrasonic waves, when attached to the surrounding media/object. This leakage generates undesirable reflections and as a result calibration becomes challenging. Moreover, the waveguides must be protected from excessive amounts of heat, and any heat transfer from a contact interface between the object/surrounding media and the waveguide. Thus, implementation of the conventional apparatus leads to leakage and inaccurate results. Accordingly, the present disclosure discloses an apparatus for determining surface temperature.

The apparatus of the present disclosure includes a waveguide with predefined cross-section configured to be in contact with the surface of an object whose temperature is to be determined. A portion of the waveguide is coupled to a transducer provided within a transducer assembly. The transducer in configure to supply ultrasonic signals to at least a segment of the waveguide which is not in contact with the object and to receive reflected signals from the waveguide. Further, a data acquisition unit is coupled to the transducer to determine the surface temperature at one or more positions of the object based on the received reflected signals. Thus, the apparatus of the present disclosure aids in determining the temperature of the object without any unwanted leakage of the ultrasonic signals as the change in properties of pre-defined cross section waveguide is eliminated. Moreover, supplying ultrasonic signals to a segment of the waveguide enables rapid calibration of the signals to provide accurate surface temperature of critical components/objects. This may aid in accessing effective performance and reliable continuous monitoring of the critical components/objects.

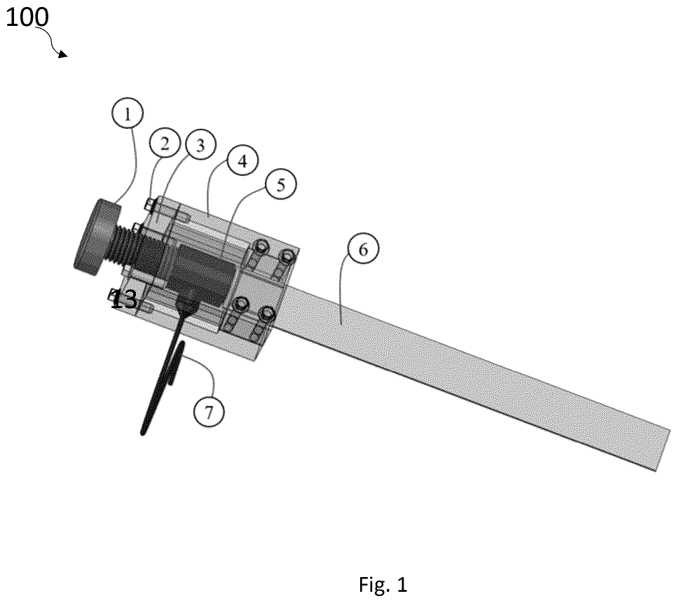

The following paragraphs describe the present disclosure with reference to FIG. 1 to FIG. 9. In the figures, the same element or elements which have similar functions are indicated by the same reference signs. Referring to FIG. 1 to FIG. 9 which are exemplary embodiments of the present disclosure illustrating an apparatus for determining surface temperature (100) [interchangeably referred as “apparatus”].

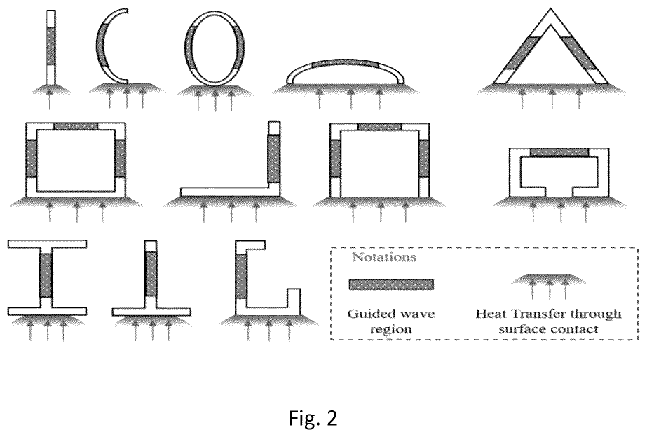

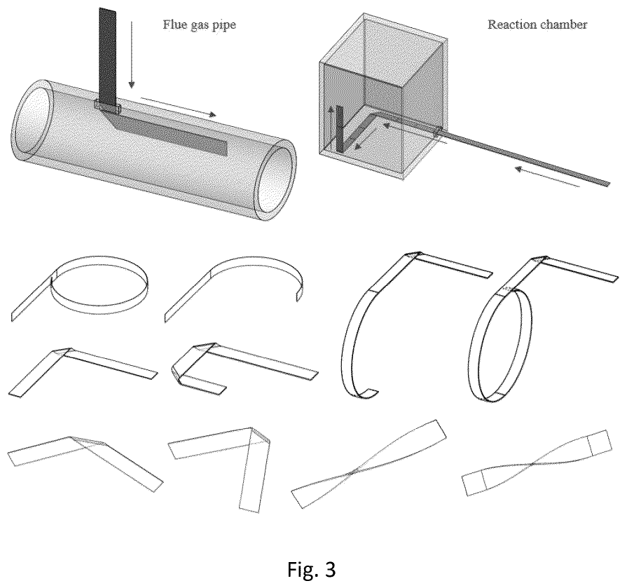

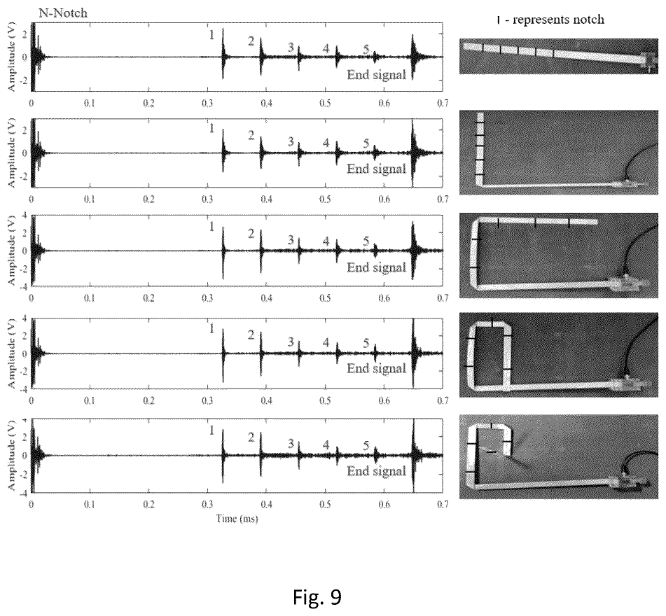

The apparatus (100) includes an elongated waveguide [also referred as “waveguide”] defining a pre-defined cross section. Further, at least a portion of the pre-defined cross section of the elongated waveguide (6) is in contact with the object to determine the surface temperature. The waveguide (6) may have configurations, such as linear, meandering, circular, spiral, etc. with the configuration optimized for the determining surface temperature of the object having a pre-determined shape and configuration. The waveguide (6) configuration can be designed to get surface temperature in a confined volume or over a very large volume through appropriate shape of the waveguide. In an embodiment, the pre-defined cross-section of the waveguide (6) is at least of rectangular, circular, cylindrical, elliptical, triangular, I shaped, U shaped, T shaped, V shaped, L shaped, diamond or any polygonal shaped. For example, referring to FIG. 2, a C-shaped waveguide (6) is illustrated, where at least a bottom portion of the C-shaped waveguide is configured to be in contact with the object to determine the surface temperature. Here, heat transfer from the object to the contact surface of the C-shaped wave guide. Similarly, all profiles of the waveguide indicated in FIG. 2, have only at least a portion to be in contact with the object. In an embodiment, the waveguide (6) with pre-defined cross-section that is in contact with the object, is made of meta-material. This prevents leakage of waves into the surface of the object in contact with the waveguide. The waveguide (6) may be in the form of a solid rod; wire, plate, sheet, etc. In another embodiment, the waveguide (6) may be defined with grooves adjacent to the at least a portion of the waveguide (6) that in contact with the object and remaining portion of the elongated waveguide. The presence of grooves also confine the transmission of the ultrasonic signals to the confined space and also prevents leakage of signals to the object. In an embodiment, the waveguide (6) is defined with one or more bends. Some of the possible configurations of bends for a flat strip waveguide (6) are shown n FIG. 3. The waveguide (6) is defined with a series of spaced apart notches or holes to enable multi point distributed surface measurement along the length of the waveguide (6) as shown in FIG. 9. The grooves, bends and the notches or holes are structured to act as periodic or a non-periodic reflectors to determine variations at the multiple predefined reflector locations, and the surface temperature can be mapped. The grooves may be either through hole or symmetric type of notch can be used for the development of sensor. Further, based on a thickness of the waveguide (6) type of groove i.e., notch or through hole can provided.

The apparatus (100) further includes a transducer assembly. The transducer assembly includes at least one transducer (5). In an embodiment, as shown in FIG. 1, the transducer (5) is enclosed by a side casing (4) removably coupled to a top casing (3) via a plurality of fasteners (2). The transducer (5) is coupled to the waveguide (6) for supplying ultrasonic signals into and along a length of the waveguide (6) and for detecting reflected signals from the waveguide (6). In an embodiment, one end of the waveguide (6) is coupled to transducer (5) and other end is configured to be in contact with the object. In an embodiment, other end of the waveguide (6) having reflectors permit multiple interactions between the ultrasonic signals and the reflector. Further, the ultrasonic signals supplied by the transducer (5) are ultrasonic shear horizontal wave signals. The transducer (5) is configured to supply the ultrasonic signals along at least one segment of the pre-defined cross-section of the elongated waveguide (6) which is not in contact with the object. Further, the transducer assembly includes an adjust mechanism (1) to adjust a position of contact of the transducer (5) with the waveguide (6). This adjustment of the position of contact allows shifting the segment of the waveguide (6) through which ultrasonic signals are supplied and received. In an embodiment, the adjust mechanism is a knob screw that can be rotated to adjust a position of contact of the transducer (5) with the waveguide (6).

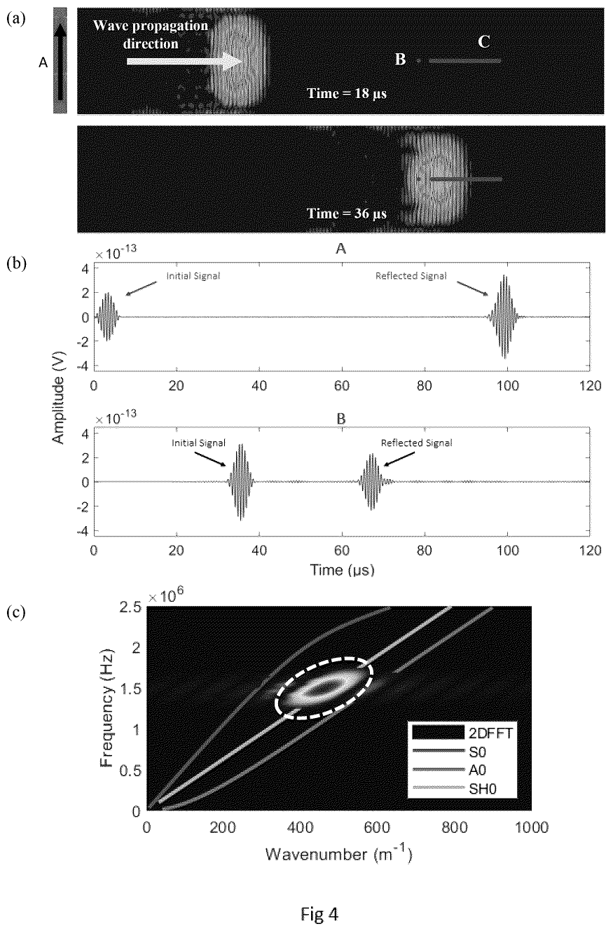

In an example, FIG. 4 illustrates optimised results of a flat strip waveguide (6) supplied with ultrasonic shear horizontal wave signals. For optimization of various parameter finite element analysis is performed in ABAQUS™. For the analysis 20 mm width, 1 mm thick and 150 mm long aluminum flat strip waveguide (6) is selected and modelled in dynamic explicit module in ABAQUS™ (of DASSAULT SYSTEMES SIMULIA CORP). An excitation sinusoidal pulse of 1.5 MHz frequency, 10-cycles tone-burst, Hanning-windowed is used to generate pure shear horizontal like mode in the flat strip waveguide (6). Referring to FIG. 4(a), shear excitation is provided in the left end cross section of the strip at surface A (orange color region). Here, a location of signal excitation and reception is labelled as ‘A’. Time domain waveforms are recorded at the excitation as well as along the direction of propagation i.e., at point B. To verify the generated mode, time domain waveforms are acquired for a set of 100 monitoring points (denoted by set C) along the direction of wave propagation at a spatial resolution of 0.2 mm to generate a two-dimensional fast Fourier transform (2D FFT) plot as shown in FIG. 4(b). Location of the points A, B and set C are identified. From 2D FFT plot using points in set C we it is observed that only shear horizontal wave like mode at 1.5 MHz is being generated.

The apparatus (100) also includes a data acquisition unit (7) which is coupled to the transducer to receive the reflected signals and to determine the surface temperature at one or more positions of the object. Once the ultrasonic signals are supplied along a segment of the waveguide (6) having the reflector such as grove or bends, signal tends to reflect at the points where reflector are provided. These reflected signals are detected and recorded using the transducer (5) and data acquisition unit (7). In an embodiment, necessary ultrasonic amplitudes and time of flights are obtained from the reflected signal and the properties of the waveguide (6) material and the surface temperature of the object at a particular region is calculated. This reflected wave and consequently the transmitted wave contains information regarding the local information around the sensor locations. By the data acquisition unit (7), the reflected and/or supplied ultrasonic signals are converted into electrical signals and the signature of these signals are analyzed to provide the information about object, surrounding media of the waveguide (6) at each location of sensor/reflector locations. The local information measurements of the surrounding media and object that can be measured may include physical properties such as temperature, pressure, viscosity, density, humidity, flow, level, strain, stress, moduli, coefficient of thermal expansion, ultraviolet radiation, magnetic and electric fields, etc., and chemical properties such as chemical composition, concentrations, reactions, cross-linking. Multiple properties can be simultaneously measured using different ultrasonic measurements viz. amplitude, time of flight, frequency, etc. Further, the data acquisition unit (7) includes an ultrasonic receiver coupled to any computing (19) for analysing the reflected/supplied signals by pulse generator and receiver (18). In an embodiment, the received may be formed as a part of the transducer assembly.

### Experimental Validation:

### 1. Experiment Setup

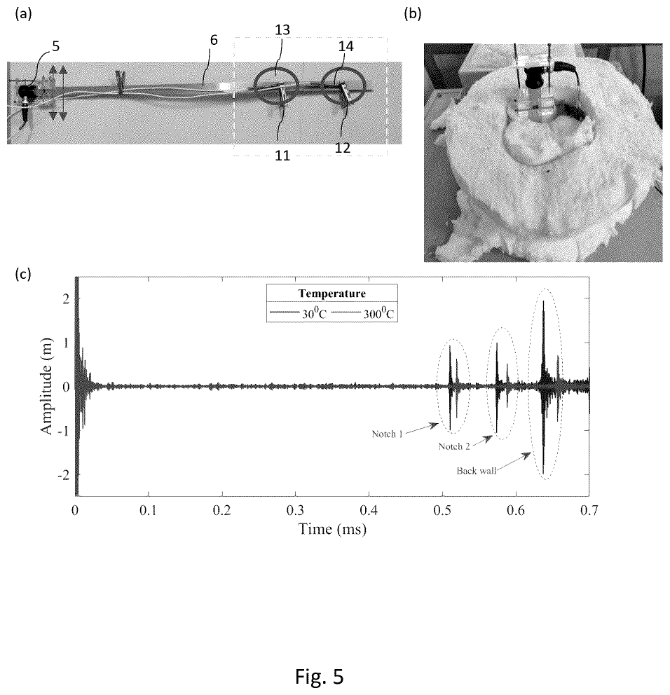

To validate a developed sensor, a flat strip waveguide (6) is prepared with optimized notches for sensing. Apparatus described above is used here. The apparatus includes a shear contact transducer (5) with 1.5 MHz central frequency. The excitation signal is a tone-burst, Hanning windowed sinusoidal pulse of 4.5 us pulse width. The transducer (5) is clipped to the flat strip waveguide (6) as demonstrated in FIG. 5(a) to ensure legitimate contact. A polarization heading of the transducer (5) is held corresponding to a width of the flat strip waveguide (6). The transducer (5) is acoustically coupled to the flat strip waveguide (6) by means of silica-based gel (Metroark 211 compound, Wacker Metroark Chemicals Pvt. Ltd., Chandi, India). The OPLabBox ver. 2.0 (Optel z.o.o, Wroclaw, Poland) is used as the pulse generator/receiver (18) while PicoScope 4000 series (Pico Technologies Ltd., St Neots, UK) is used for the digitization and acquisition of the received waveforms. The A-scan signals are sampled at a rate of 400 MHz and time averaged for 128 signals. Two resistance temperature detectors (RTD) (11,12) are placed locally within each of the sensors (13,14) as shown in FIG. 5(a).

### 2. Calibration:

The flat strip waveguide (6) as shown in FIG. 5(a) is heated to a temperature of 300° C. The experimental setup i.e., furnace as shown in FIG. 5(b) is covered with a glass wool to ensure proper insulation and a steady-state temperature over the flat strip waveguide (6) as shown in FIG. 5(b). During a heating cycle from room temperature (30° C.) to 300° C., time-domain waveforms are captured continuously using the PicoScope while the temperature data obtained from the RTDs (5,6) are recorded using a temperature data logger 85XX+DAQ (Masibus Automation and Instruments Pvt. Ltd., Gujarat, India).

Time domains waveforms recorded for the room temperature and 300° C. is plotted in the FIG. 5(c). It is observed that there is a shift in the time of flight (ToF) of the reflected signals from the notches with an increase in temperature. Further, there is simultaneous reduction in the amplitude due to the attenuation. The sensor is calibrated by correlating the RTD temperature with change in ToF of the reflected signals. The calibration equations are derived upon postprocessing, and peak tracking of the A-scan signals recorded during the heating cycle.

### 3. Surface Temperature Prediction:

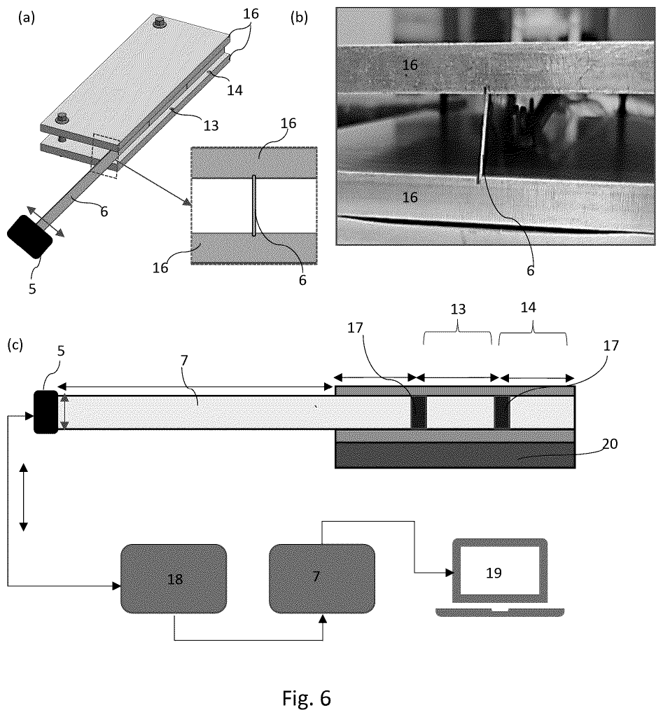

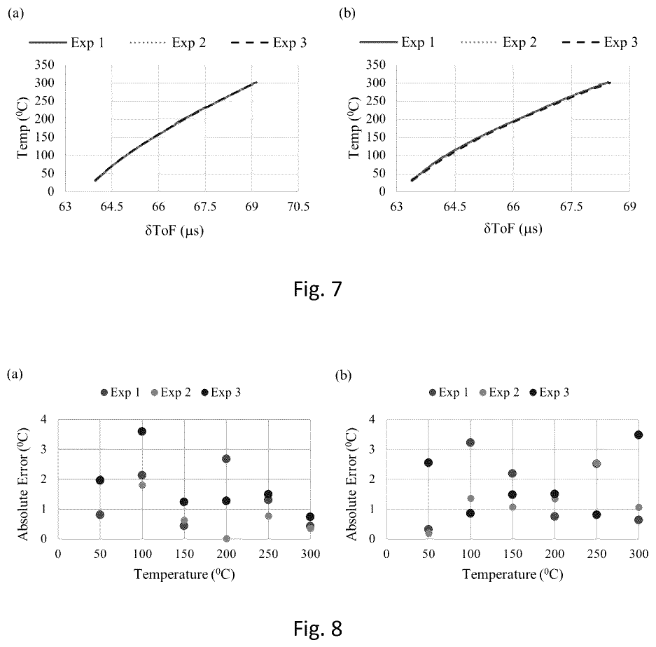

The flat strip waveguide (6) is positioned in between two plates (16) in such a way that the sensors (13,14) are inside the high temperature zone via a heating source (20) as shown in FIG. 6(a). Apart from this same equipment's are used as described for FIG. 1 and FIG. 5. Referring to FIG. 6(c) a schematic view of the setup for surface temperature measurement is provided. Three experimental trials are performed using the flat strip waveguide (6). The two plates (16) temperature (recorded by RTDs) is compared against the respective values obtained by the sensors (13,14), as shown in FIGS. 7(a) and 7(b). Based on both temperature plots it is understood that the trials follow a similar trend, thereby reaffirming that the experiments are repeatable in nature. Using the derived calibration equations of each sensor, the plate (16) temperature is predicted by substituting the STOF obtained from the notch reflections (17) for the trails. The absolute error in the prediction of plate surface temperature is plotted for every 50° C. increase in temperature, which is shown in FIGS. 8(a) and 8(b). The average absolute error is in the range of 2-3° C., for the number of trials conducted

$$Absolute error = \vert {T}_{predicted} - {T}_{actual} \vert$$

where T_{predicted} (in ° C.) is the temperature value obtained using the calibration equation while T_{actual} (in ° C.) is the reference temperature measured using RTD.

### 4. Experiment Validation of Reconfigured Flat Strip Waveguide

A 1-metre-long flat strip waveguide is used to verify the reconfigured flat strip waveguide. Shear horizontal waves signals are generated by the transducer. Further, five optimized symmetric notches are fabricated in the propagation direction. Time domain waveform for few reconfigured flat strip samples is shown in the FIG. 9. In the time domain waveforms, there is no presence of reflection from the bend which is proved in the previous section using numerical analysis for bend effects. It can be concluded that flat strip waveguides can be reconfigured into different form as per the requirement. This allows temperature profile measurement such as temperature measurement of an inner surface of a flue gas carrying pipe, temperature profiling inside a reaction chamber in multi directions as shown in FIG. 3.

In an embodiment, the design of the structure and dimensions of the components of the apparatus (100) such as the transducer (5), adjustment mechanism may be altered based on the requirements/application. Additionally, the apparatus (100) can be altered based on any pre-defined profile of the waveguide.

In an embodiment, the configuration of the apparatus (100) having pre-defined waveguide (6) with at least a portion to be in contact with the object and supply of ultrasonic signals to a segment of the waveguide (6) eliminates leakage of the guided waves contained inside the waveguide. The waveguide (6) is reconfigurable waveguide (6) due to limited contact with the object.

The present disclosure also discloses a method for determining surface temperature of an object. The method includes initially providing an elongated waveguide (6) having a predefined cross-section and a portion of the pre-defined cross-section of the elongated waveguide (6) is configured to be in contact with a surface of an object whose surface temperature is to be measured. Then, a position of contact of the transducer (5) with the waveguide (6) is selectively adjusted to shift the segment through which ultrasonic signals are supplied and received. The method also include supplying ultrasonic signals into the elongated waveguide (6) and reflected signals from the elongated waveguide (6) are detected, using at least one transducer (5) coupled to the waveguide (6). The ultrasonic signals are supplied along at least one segment of the pre-defined cross-section of the elongated waveguide (6) which is not in contact with the object. The surface temperature of the object is determined based on the received reflected signals.

It is to be understood that a person of ordinary skill in the art may develop an apparatus of similar configuration without deviating from the scope of the present disclosure. Such modifications and variations may be made without departing from the scope of the present invention. Therefore, it is intended that the present disclosure covers such modifications and variations provided they come within the ambit of the appended claims and their equivalents.

An apparatus (100) in accordance with the present disclosure that is simple and easy to operate.

An apparatus (100) in accordance with the present disclosure comprises pre-defined cross-section waveguide (6) aid in capturing surface temperature gradient of different cross section.

An apparatus (100) in accordance with the present disclosure with predefined waveguide (6) is reconfigurable, which is economical to conduct multiple calibrations.

An apparatus (100) in accordance with the present disclosure comprises transducer to supply ultrasonic signals for only a segment of the waveguide (6) eliminates change in mechanical properties of the waveguide, thereby eliminating leakage of signals to determine precise surface temperature of various sizes and geometries of object.

An apparatus (100) in accordance with the present disclosure provides of high accuracy values for critical/difficult to access components.

### Equivalents

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

List of reference numeral

| Numeral | Particular |
|---|---|
| 100 | Apparatus |
| 1 | Adjusting mechanism |
| 2 | Plurality of fasteners |
| 3 | Top casing |
| 4 | Side casing |
| 5 | Transducer |
| 6 | Waveguide |
| 7 | Data acquisition unit |
| 11, 12 | Resistance temperature |
| | detectors (RTD) |
| 13, 14 | Sensors |
| 16 | Plates |
| 17 | Notch reflector |
| 18 | Pulse generator and |
| | receiver |
| 20 | Heating source |

1. An apparatus for determining surface temperature of an object, the apparatus comprising:
an elongated waveguide defining a predefined cross-section, wherein at least a portion of the pre-defined cross-section of the elongated waveguide is in contact with a surface of an object whose surface temperature is to be measured;
a transducer assembly comprising, at least one transducer being coupled to the elongated waveguide for supplying ultrasonic signals into the elongated waveguide and for detecting reflected signals from the elongated waveguide, wherein the transducer is configured to supply the ultrasonic signals along at least one segment of the pre-defined cross-section of the elongated waveguide which is not in contact with the object;
a data acquisition unit coupled to the transducer to receive the reflected signals and determine the surface temperature at one or more positions of the object.

2. The apparatus as claimed in claim 1, wherein the ultrasonic signals are ultrasonic shear horizontal wave signals.

3. The apparatus as claimed in claim 1, wherein the elongated waveguide is defined with a series of spaced apart notches or holes to enable multi point measurement of the surface temperature.

4. The apparatus as claimed in claim 1, wherein the cross-section of the elongated waveguide is at least of rectangular, circular, cylindrical, elliptical, triangular, I shaped, U shaped, T shaped, V shaped, L shaped, diamond or any polygonal shaped.

5. The apparatus as claimed in claim 1, wherein the elongated waveguide is defined with one or more bends.

6. The apparatus as claimed in claim 1, wherein the at least one portion of the elongated waveguide that in contact with the object, is made of meta-material.

7. The apparatus as claimed in claim 1, wherein the elongated waveguide is defined with grooves adjacent to the at least a portion of the elongated waveguide that in contact with the object and remaining portion of the elongated waveguide.

8. The apparatus as claimed in claim 1, comprises an adjust mechanism configured to adjust a position of contact of the transducer with the elongated waveguide to shift the segment through which ultrasonic signals are supplied and received.

9. A method for determining surface temperature of an object, the method comprising:
providing an elongated waveguide defined with a predefined cross-section, wherein a portion of the pre-defined cross-section of the elongated waveguide is in contact with a surface of an object whose surface temperature is to be measured;
selectively adjusting, a position of contact of a transducer coupled with the waveguide to shift the segment through which ultrasonic signals are supplied and received; and
supplying ultrasonic signals into the elongated waveguide and receiving reflected signals from the elongated waveguide, using at least one transducer coupled to the waveguide, wherein the ultrasonic signals are supplied along at least one segment of the pre-defined cross-section of the elongated waveguide which is not in contact with the object;
determining the surface temperature of the object based on the received reflected signals.
